(19) United States
(12) Patent Application Publication
(10) Pub. No.: US 2025/0021907 A1
(43) Pub. Date: Jan. 16, 2025

(54) NONLINEAR MANAGEMENT SYSTEM AND METHOD

(71) Applicant: Colleen O'Rourke, Port Charlotte, FL (US)

(72) Inventor: Colleen O'Rourke, Port Charlotte, FL (US)

(21) Appl. No.: 18/758,516

(22) Filed: Jun. 28, 2024

Related U.S. Application Data
(60) Provisional application No. 63/526,218, filed on Jul. 12, 2023.

(51) Int. Cl. G06Q 10/0637

(52) U.S. Cl. CPC G06Q 10/0637

(57) ABSTRACT

A System framework manages a team or organization in a nonlinear manner. This system framework is implemented by gathering, organizing, and analyzing specific types of information, with a particular mindset and generating decisions based on that analysis. This framework can be implemented through an individual manager's performance, or a group of managers and leaders, aided by tools such as templates, documents, or a computer-implemented version of the system framework. The System framework has a set of fundamentals and interconnections, a nonlinear mindset, system flows, values, levers, rules for self-organization, and guidelines for handling emergence of ideas within the organization. A user device, a server, and a processor are configured to execute a set of program instructions, which provides a user with a visual representation of the framework via a display unit of the user device. The visual representation comprises a transformation layer for managing the nonlinear mental model, including mindset, coping with unpredictable changes, enacted values, and aspects of culture. A goals and controls layer comprises various parameters, including boundaries, outcomes, critical compliance rules and flows, and the degree of support for agent self-organization. A plan, anticipate, and execute layer is configured to manage the people, processes, tools, artifacts, interconnections, and system rhythms from a nonlinear mindset to ensure ongoing success, including tracing the flows of valuable resources. A layer assesses the response/reactions to present moment information. The layers are arranged in an ascending manner starting from the transformation layer to the respond/react layer. A data input module receives an input defining at least one of the boundaries and an outcome. A database fetches attributes stored in input information by the user and parameters governing fundamentals essential to the organization.

This Application claims the benefit of Application Ser. No. 63/526,218, Filed Jul. 12, 2023, entitled Nonlinear Management System And Method.

### BACKGROUND OF THE INVENTION

### 1. Field Of The Invention

The present invention relates to management systems and methods and, more particularly, to the application of systems thinking, specifically elements of Complex Adaptive Systems, to management theory to create nonlinear management systems and/or methods for managing people and work in an organization.

### 2. Description Of The Prior Art

System thinking is a holistic way to investigate factors and interactions that could contribute to a possible outcome. This relates to management theory in that the outcome of management is the coordination and administration of work to achieve a goal. Management frameworks in existence today focus on Sequential Management, which limits the discipline to sequential views of work to be done to achieve a goal. However, work and the management of work in a complex environment are not at all related to the sequential completion of assigned tasks.

On the other hand, the holistic nature of Systems Thinking, as presented in the book Thinking in Systems by Donella H. Meadows (Meadows, Donella H., Thinking in Systems, Chelsea Green Publishing, 2008), provides aspects of complex system construction that are beyond sequential (linear) systems while preserving the fundamental objective to achieve a goal. The holistic nature of Systems Thinking makes clear the full range of instruments that are available to achieve management goals. The original work in this patent reinterprets the science of systems thinking into a new management framework, thereby providing new ways to describe, teach, and perform the art of business management.

Additional information on systems thinking from the Systems Innovation Udemy Courses: Complex Adaptive Systems, Nonlinear Systems, and Systems Theory, was used as a basis from which to reinterpret system constructs into management constructs. These sources have provided a view of System Thinking, which this work has reinterpreted and provided new insight into management theory. These courses were accessed through Udemy.com in July and August of 2019 (https://www.udemy.com/user/fotonlabs/).

The following research papers contributed some of the properties of the Nonlinear Mental Model:
Alaa, G., & Fitzgerald, G. (2013). Re-Conceptualizing Agile Information Systems Development using Complex Adaptive Systems Theory. Emergence, 15, 1-23.
Kautz, K. (2012). Beyond simple classifications: Contemporary information systems development projects as complex adaptive systems. 22.
Meso, P., & Jain, R. (2006). Agile Software Development: Adaptive Systems Principles and Best Practices. Information Systems Management, 23 (3), 19-30. https://doi.org/10.1201/1078.10580530/46108.23.3.20060601/93704.3
Onix, M. F. A., Fielt, E., & Gable, G. (2017). Complex adaptive systems theory in information systems research: A systematic literature review. In S. C. Ling, S. Bahri, & P. Finnegan (Eds.), Proceedings of the 21st Pacific Asia Conference on Information Systems (PACIS) 2017 (pp. 1-14). Association for Information Systems (AIS). http://aisel.aisnet.org/pacis2017/271/
Srinivasan, B. N., & Mukherjee, D. (2018). Agile teams as complex adaptive systems (CAS). International Journal of Information Technology, 10 (3), 367-378. https://doi.org/10.1007/s41870-018-0122-3
Sweetman, R., & Conboy, K. (2018). Portfolios of Agile Projects: A Complex Adaptive Systems' Agent Perspective. Project Management Journal, 49 (6), 18-38. https://doi.org/10.1177/8756972818802712
Vidgen, R., & Wang, X. (2006). Organizing for agility: A complex adaptive systems perspective on agile software development process. ECIS 2006 Proceedings. https://aisel.aisnet.org/ecis2006/87
Vidgen, R., & Wang, X. (2009). Coevolving Systems and the Organization of Agile Software Development. Information Systems Research, 20(3), 355-376. https://doi.org/10.1287/isre.1090.0237
Werder, K., & Maedche, A. (2018). Explaining the emergence of team agility: A complex adaptive systems perspective. Information Technology & People, 31(3), 819-844. https://doi.org/10.1108/ITP-04-2017-0125
Whitney, K. M., & Daniels, C. B. (2013). The Root Cause of Failure in Complex IT Projects: Complexity Itself. Procedia Computer Science, 6.

There are various advantages associated with the nonlinear management of people and work as compared to a linear management approach. The benefits can be grouped into three categories: Strategic Agility, Operational Agility, and Innovation Agility.
Strategic Agility is the ability to shift the goals of the organization quickly to respond to changes in the market, technology, politics, etc. The result is that the entire organization is more strategic in their thinking and problem-solving and is more aligned with organizational goals even as they shift.
Operational Agility is the ability to shift the outputs of the organization quickly to respond to changes in strategy, innovation, new technology, competitor/market changes, or new customer information. The result is that products and services are more aligned with the market.
Innovation agility is the ability to generate and recognize new ideas, discern which ones will contribute to the organization's goals and strategies, and move quickly to implement them.
Across the organization, these changes amount to:
   High adaptability, responding to outside events quickly to still achieve the outcome;
   High survivability, repairing their own deficiencies; and
   High self-organization, creating new elements and interconnections to meet a wide variety of disruptions.

A nonlinear management system (NMS) comprises many aspects all of which are based on a foundational concept called a Nonlinear Mental Model, as illustrated in FIG. 1.

A complete NMS, as described by the above modeling, may contain many different components and may look like the one illustrated in FIG. 2. This typical NMS mainly comprises certain fundamentals: The nonlinear mental model, outcomes, critical rules and flows, self-organization, elements, interconnections, data points, feedback loops, and levers. The system is designed to manage its flow and movements toward outcomes and support decision-making through such movements and changes. The system is also designed to manage the overall resilience of the system to deliver outcomes in case of a crisis, disruption, or growth.

Levers, as described in this framework, are a reinterpretation of the work of Donella Meadows in her paper Leverage Points: Places to Intervene in a System (Meadows, Donella H., Leverage Points: Places to intervene in a System, The Sustainability Institute, 1999.) The reinterpretation reframes the levers in terms of management tools.

It is very difficult to train an active nonlinear management system all at once. This problem is overcome in accordance with the present invention by introducing artificial levels to help people learn to master the aspects of an active nonlinear management system in a logical order, as demonstrated in FIG. 3.

### SUMMARY OF THE INVENTION

The present disclosure provides a system and method for managing teams or an organization in a nonlinear manner. The system is implemented by gathering, organizing, and analyzing specific types of information with a particular mindset and generating decisions based on that analysis. The system can be implemented through an individual manager's performance, or a group of managers and leaders, aided by tools such as templates, documents, or a computer-implemented version of the system framework. The system comprises a plurality of interconnected user devices and a server connected to the plurality of devices over a network. The system further comprises a processor configured to execute a set of program instructions which provides a user with a visual representation of the framework via a display unit, wherein the visual representation comprises a primary layer configured to display the set of fundamentals. The set of fundamentals comprises parameters including the mindset, dealing with emergence, enacted values, and culture, which form the foundation of a nonlinear business system. The visual representation comprises the next layer configured to contain the goals and control aspects of the system. These are the goals, rules, and various control conditions set up based on the mindset layer. This layer also contains the system rhythms based on a nonlinear mindset applied to one or more enacted values. Further, the visual representation comprises a layer built on top of the first two for configuring elements and interconnections to deliver the outcomes according to the rules established in Level 2. And finally, there is a layer that represents the present moment data and dashboards. In combination, these layers manage and deliver the resilience of the system in terms of growth and disruptions. The layers are arranged in an ascending manner, starting from the most powerful to the least powerful layer.

The system includes a data input module for receiving input defining at least one outcome. Further, the system includes a data storage and retrieval aspect, such as a database, for storing and fetching the various attributes governing the various fundamentals essential to the organization. Further, the system comprises an optimization engine for optimizing various aspects of the configuration. Further, the system includes a self-monitoring module to monitor and adjust the configuration continuously to maintain the overall health of the system.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label, irrespective of the second reference label.

FIG. 1 illustrates that the foundation component of nonlinear management systems is the nonlinear mental model;

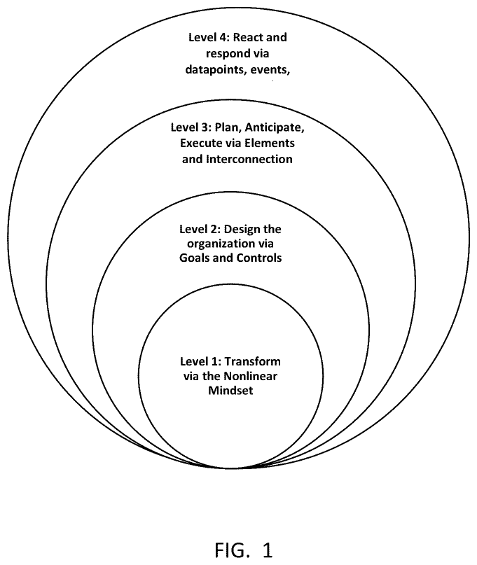

FIG. 2 represents a conventional nonlinear management system;

FIG. 3 illustrates a nonlinear management system in accordance with an embodiment of the present invention;

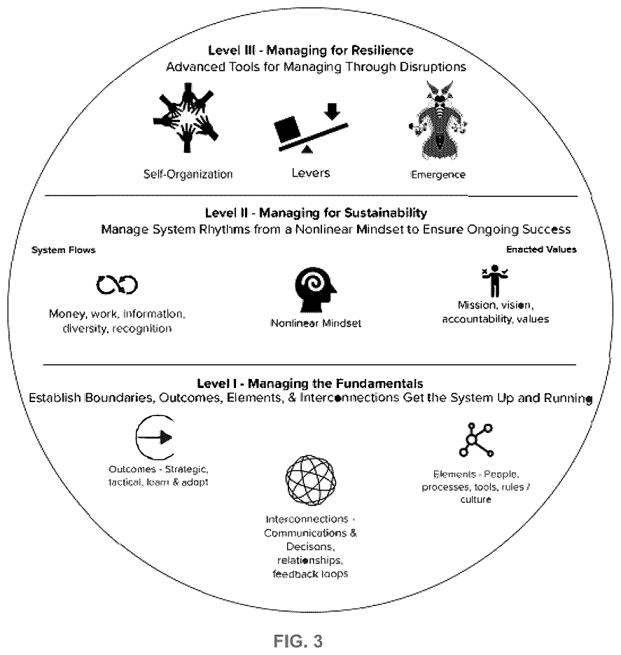

FIG. 4 illustrates an exemplary network structure employing a computer-implemented nonlinear management system in accordance with an embodiment of the present disclosure;

FIG. 5 illustrates the computer-implemented nonlinear management system of FIG. 4, in accordance with an embodiment of the present disclosure;

FIG. 6 illustrates a method flowchart depicting the creation of a nonlinear management system in an organization in accordance with the present disclosure; and

FIG. 7 represents the major areas of concern for which nonlinear managers need to create and manage outcomes in accordance with the present disclosure.

### DETAILED DESCRIPTION OF THE INVENTION

In the following description, numerous specific details are set forth in order to provide a thorough understanding of the features and the embodiments of the present invention. It will be apparent to one skilled in the art that embodiments of the present invention may be practiced without some of these specific details.

Embodiments of the present invention include various features, which will be described below. The system steps are executed by people, although a computer armed with high intelligence, having AI components, may be able to participate during the performance or may be embodied in machine-executable instructions, which may be used to cause a general-purpose or special-purpose processor programmed with the instructions to assist with the performance of system steps. Alternatively, aspects may be performed by a combination of hardware, software, and firmware and/or by human operators.

Embodiments of the present invention may be provided as a computer program product, which may include a machine-readable storage medium tangibly embodying thereon instructions, which may be used to program the computer (or other electronic devices) to perform certain aspects. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by human managers or by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to a computer program coded in accordance with various methods described herein and the method steps of the invention could be accomplished by modules, routines, subroutines, or subparts of a computer program product.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention.

A nonlinear management system is a framework that is designed to manage the complexities of a dynamic and interconnected organization. It is based on the principles of nonlinear systems, which are characterized by emergent behavior, feedback loops, and interconnectedness. Nonlinear management systems recognize that traditional linear management approaches may not be sufficient to address the challenges of the modern business environment. Instead, a nonlinear management system (NMS) provides a flexible and adaptable approach that can respond to changing conditions and facilitate collaboration between different departments and teams. Effective communication and collaboration between different parts of the organization are key features of nonlinear management systems. It provides a platform for sharing information, coordinating activities, and making decisions that take into account the interconnectedness of different parts of the organization. In addition, a nonlinear management system emphasizes the importance of feedback loops and continuous learning. It encourages organizations to continuously monitor their performance and make adjustments to their processes and systems based on feedback from their environment.

Recognizing emergent behaviors in a complex system is important, considering the pace at which the organizations are evolving. NMS acknowledges that small changes in one part of the organization can have a significant impact on the behavior of the system as a whole, and thus it provides tools and frameworks for understanding and managing emergent behavior. Managing a nonlinear framework within an organization can be a challenging task, especially when it comes to coordinating the activities of diverse teams and departments. However, by implementing a comprehensive system that is designed to manage the complexities of a nonlinear framework, organizations can streamline their operations and improve their overall efficiency.

The first step in developing such a system is to gain a thorough understanding of the organization's mental models, structures, and processes. This requires a deep analysis of the various departments, teams, and functions within the organization, as well as an assessment of the interdependencies and relationships between them. With this information in hand, a clear picture can be developed of how the organization currently operates. Once this understanding has been established, the next step is to develop a system that can manage the organization's nonlinear framework. This system should be designed to support collaboration and communication between teams and departments, as well as to facilitate the sharing of information and resources. It should also provide a framework for decision-making and problem-solving, allowing teams and departments to work together to identify and address issues as they arise.

To be effective, the system must be flexible and adaptable, able to evolve and change as the organization grows and evolves. It should be scalable, able to accommodate the needs of larger organizations, and customizable so that it can be tailored to meet the specific needs of each organization. Ultimately, the success of the system will depend on the commitment and engagement of all stakeholders within the organization. To ensure its adoption and success, it is important to involve key stakeholders in the development and implementation process, and to provide ongoing training and support to ensure that everyone understands how to use the system effectively. With the right system in place, organizations can achieve greater efficiency, agility, and resilience in a nonlinear framework.

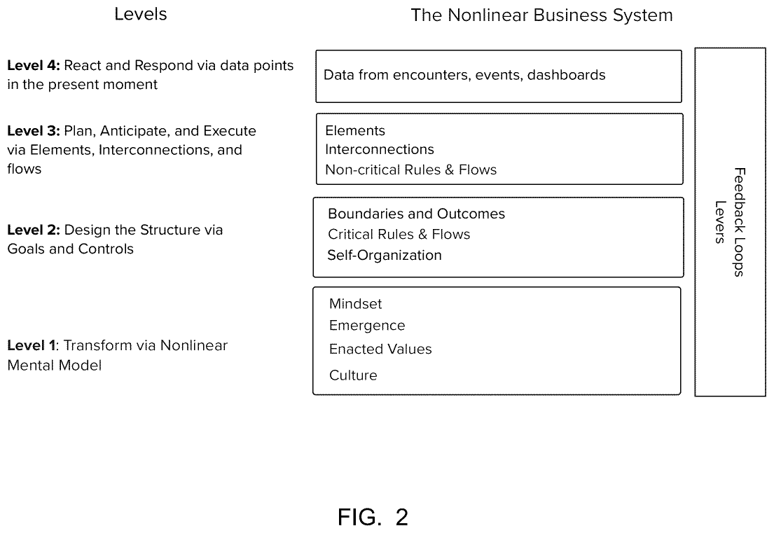

FIG. 2 illustrates a nonlinear management system in accordance with an embodiment of the present disclosure. FIG. 2 illustrates a four-level framework, namely a Transformation layer, a Goals and Controls layer, a layer for Planning, Anticipating, and Executing, and a layer for Reacting and Responding in the present moment. These layers are arranged in an ascending manner, starting from the primary Transformation layer to the Present Moment layer. These layers depict different levels of a nonlinear business system. These layers comprise various sets of fundamentals being governed for a plurality of outcomes defined under the goals of an organization based on pre-defined parameters. Spanning across all the levels are the use of Feedback Loops and Levers which provide monitoring and adjustments to the system.

Within a nonlinear business system, individuals, whether they are users, workers, managers, or executives, are all referred to as agents or individuals, as they are all equal-each is doing their job to move toward the outcomes of the system. Occasionally Managers are separated, as the tools listed herein pertain specifically to that role.

The Transform layer is to increase awareness and management of thinking and behaving that impact the work of all the layers above it. This includes the mindset of agents in the system, how the agents cope with the emergence of unknown and unpredictable situations, how they not only identify with their values but more importantly do they consistently behave in accordance with those values, and the formal and informal culture that exists at the organization.

The function of a nonlinear mindset is to enable individuals to see beyond traditional linear thinking and explore innovative solutions that may not have been considered before. It encourages individuals to approach problems holistically, considering all factors and their interrelationships and identifying creative and unconventional approaches to address them. The nonlinear mindset enables individuals to be more agile and adaptable, thus, making them better equipped to navigate uncertainty and change.

The nonlinear mindset completely counters the linear mindset principles of additivity and homogeneity with new ways of managing teams. First, the principle of additivity, the idea that two people can produce the same work equivalent as the sum of their work alone is completely dismissed as false. In a nonlinear model, the additive principle is replaced with the correct interactions that will bring about synergy-a work equivalent to greater than the sum of the work of the individuals, and the same tool-interactions--is used to avoid interference, that is, a work equivalent lower than the sum of the individuals. This removes predictability, but proper use of interactions can produce significant improvements in work output.

The second linear principle, that of homogeneity, that all parts of systems that appear equal are equal (for example, people similarly trained or tools from different vendors) is equally invalid in a nonlinear system. The variables between any two people or tools can be so unequal as to be not worth tracking. Instead, in the nonlinear mindset, the organization must establish two key principles: trust in the workers and feedback loops. The idea of trusting the workers to know what they need is new to some people, as there is an assumption that if given a chance, people will slack off, get lazy, and do less work than they are capable of. However, this is rarely the case with knowledge workers. They are passionate about their work, want to exercise their skills, and genuinely want to help. If a manager does not have this type of person, either that manager has the wrong person or is not the right manager for them.

The NMS abandons the predictability of the linear principles of additivity and homogeneity and embraces diversity, innovation, failure, and correction through experimentation and constant improvement as the preferred method for achieving outcomes.

Additional components of the nonlinear mindset include:

| | |
|---|---|
| All elements of a system | People and their use of processes are not equivalent; they are |
| are heterogeneous | diverse, and it is their diversity that drives adaptability and |
| | innovation. Nonlinear managers will seek out different agents |
| | for different perspectives. |
| People in the systems are | People make decisions about their work. Nonlinear managers |
| autonomous. | will help agents make decisions that drive toward achieving the |
| | outcomes. |
| People are interconnected | Nonlinear managers will ensure interactions are healthy and |
| | productive. |
| People have a simple set of | Nonlinear managers know when to create or change rules to help |
| rules or beliefs from which | the team drive towards their outcomes. |
| they operate | |
| People share a common | A system drives towards its outcomes, not egos. Nonlinear |
| goal. | managers constantly keep the outcomes front and center in |
| | decision-making and all egos in check. |
| The system senses and | Nonlinear managers are constantly sensing the environment to |
| adjusts to the environment. | get ahead of any potential disruptions or synergies for the team |
| | to adjust to. |
| People interact with other | It is the opposite of linear silo or solo work, this states that |
| people in the system. | barriers to interactions need to be removed and interactions |
| | between people encouraged. Nonlinear managers ensure that |
| | agents are interacting in a healthy manner, encouraging |
| | discussions and alternative ideas. |
| A rhythm of interactions | The cadence, heartbeat, or rhythm of interactions drives the |
| develops, which drives the | achievement of outcomes. Faster isn't better, slower isn't better, |
| momentum of the system. | but an appropriate rhythm to interactions is needed. What that |
| | rhythm is will depend on the team and their current needs. |
| | Nonlinear managers drive the rhythm of interactions to maintain |
| | team momentum. |
| People learn from past | People in the system must: |
| behaviors, and this learning | Question assumptions and beliefs |
| impacts how they interact | Be open to change |
| in the present. | Demonstrate role elasticity |
| | Cultivate confidence by leaving the comfort zone |
| | Embrace feedback culture |
| | Allow people to fail |
| | Nonlinear managers ensure not only time for reflection and |
| | learning but also find tools to help the team learn and provide a |
| | safe environment free from blame or judgment for mistakes that |
| | generate learning. |
| People are free to | People feel supported to conduct controlled experiments to |
| experiment. | improve outcomes. They are naturally curious and creative and |
| | open to new ideas and perspectives. |
| Nonlinear teams are self- | Nonlinear managers are constantly assessing the degree of skill |
| organized. | of the agents to self-organize and will push a team to handle as |
| | much self-organization as is healthy, but no more. They will also |
| | be bringing new tools to the team to help them self-organize in |
| | more effective ways. |
| Order in the system | Order, in this sense, is obtained through feedback loops that |
| emerges through the | inform nonlinear managers that outcomes will or will not be |
| interactions of the people, | achieved. This information should come as early as possible and |
| not through any specific | allow the teams to adjust as necessary. |
| component. | |
| The system will | A healthy nonlinear system will have new ideas and behaviors |
| demonstrate the emergence | appearing often. |
| of new ideas and behaviors | |
| The system will be | Nonlinear managers lean deeply into the use of outcomes to |
| unpredictable due to the | continue to drive the system agents to a common goal |
| emergence of new ideas | throughout the changes along the way. |
| and behaviors. | |
| The system will evolve. | A healthy nonlinear system is always incorporating new |
| | behaviors to improve itself. |
| A small change in any part | This is a normal part of a nonlinear system, and healthy systems |
| of the system can lead to a | can self-correct quickly if the new larger change does not serve |
| larger change in the whole | the outcomes. |
| system. | |
| The system may result in | While innovation is not guaranteed, it is almost a given that |
| innovative solutions to | innovation will result from a healthy nonlinear system. |
| problems it encounters | |

The NMS provides guidance on coping with the phenomena called emergence, where new things are created when combining things in new and dynamic ways. Specifically, the NMS provides tools including creating attractors and detractors (positive and negative feedback loops), oblique approaches (and avoiding direct approaches), and awareness of innovation and unintended consequences to continue to drive the system towards outcomes.

Enacted values are the values that people use day in and day out to make decisions and carry out work. When espoused values and enacted values are aligned, establishing strategy and outcomes are improved, stakeholder relationships and reputation are improved, and decision-making is improved. However, misaligned espoused and enacted values can result in poor performance, damage to the brand, and distrust among the people. In the NMS, managers need to ensure that enacted values are aligned with the espoused values for everyone in a team, and if not, call out the problem and work with the individuals to resolve the misalignment, even if those individuals are higher ranking than the manager.

Culture includes the formal and informal manner in which the agents interact and includes such things as decision-making (how decisions are really made, not just how they are professed to be made). This concept of decision-making extends quite far. For example, do undo weight being given to certain parts of the organization over another as found in sales-driven organizations or engineering-driven organizations. For example, a company may have a formal rule that says all work should be customer-focused, yet the same company will not fund customer research, customer support, or talent to build customer-centric features. This company has an informal rule that customers are not important. Together these formal and informal choices create a culture that lacks integrity.

The Goals and Controls layer is to manage certain fundamentals: boundaries, outcomes, critical rules and flows for maintaining compliance, and the support for, or suppression of, agents to perform in a self-organized manner. Within the boundary, the outcomes need to be defined. There can be, and often are, more than one outcome for each boundary. The boundary may be defined as an area of concern that groups common outcomes, such as strategy, tactical execution, ongoing learning, and the market in which the organization participates. The outcomes are defined through a series of goals and rules for achieving them. In the NMS, both the boundary and outcomes are radically shifted from traditional views, and hence form the basis for a new perspective of management.

A nonlinear system can interact with other parts in other systems almost to infinity. Attempts to describe everything in an ecosystem, from a cellular to a global level, tend to traverse many different specialties and require massive amounts of time and research. So, when working with nonlinear systems, rough boundaries are drawn to direct the work to a particular part of a given larger system. The NMS uses boundaries to loosely define a perspective into what is a larger system.

While there are many ways to define boundaries, the recommended method is to group them into three categories: Strategic, Tactical, and Measure and Adapt. It is to be noted here that for a true nonlinear system, one must have a Measure and Adapt set of outcomes along with a budget for these outcomes, as this is what contributes significantly to long-term adaptability and sustainability in the system. For each category of outcomes, there are four recommended lenses: Organization (Internal-looking), Market (External-looking), Customer (Detailed customer problems), and Sustainability (Improvement-perspective). Taken together, these form a total of 12 areas of concern, and the nonlinear manager needs to create and maintain outcomes within each. A nonlinear manager must drive team creation and buy-in of all the outcomes, align the outcomes across the organization, and track and report progress on the outcomes.

While the boundaries may seem fairly universal, for example, a Product Line Manager may have the same or similar-looking boundaries as one of their Product Managers, the outcomes within those boundaries will differ. This is why the combination of boundaries and outcomes is critical to get right.

Outcomes are defined through three aspects: the desired result of the system-what the system is trying to achieve, the rules, and measures and metrics to monitor the progress. The desired result of an outcome is often lost when writing traditional management goals. The desired result is not necessarily specific, measurable, or time-bound but it is the true purpose of the system. In an adaptable system, this allows agents to drive towards the correct ending without forcing measurable statistics on how they will get there.

The Rules allow agents to pursue the desired result without compromising the organization. Rules may include, for example, the following:
something one must keep (such as safety); these are called Stakes;
something one can't go overboard on (such as too much noise), these are called Guardrails; and
how to handle mistakes (such as apologies), which is called Exception Handling.

These rules increase the manager's ability to adapt and respond to changing environments dramatically without creating chaos.

There additionally exist metrics for measuring progress or deviation from the outcome. These metrics may include example SMART goal(s), which allows agents to see how the organization views as a path for achieving the desired result. Metrics should not only measure progress, but also attempt to provide feedback that no unintentional harm is done.

For example, under the personal growth general outcome, one can examine how it can become a documented outcome.

### Desired Results:

1) To deepen the well of work-related skills for the organization without having to add headcount.
2) To expand the skills of all individuals in the organization.
3) For individuals to have teaching and learning experiences, resulting in unscripted shared experiences between individuals in the organization that might not otherwise happen.

### Measurements and Metrics:

1) Over the course of the coming year, each individual will learn at least one skill in their area of expertise and present an overview of that skill to a larger audience in the organization in a 1-hour volunteer participation synchronous or asynchronous event. Volunteer participants will provide a simple input to the individual's annual review on how well they achieved one or more of the desired results.
2) Over the coming year, each individual will learn at least one skill outside their area of expertise yet still applicable to this organization's work. The individual will be rated by their mentor (if using a mentor from inside the workplace) or their own manager (if gaining training outside the organization), and the rating will be evaluated at their annual review.
3) Over the course of the coming year, senior members of the organization (grade level x and above) will mentor at least 1 individual from the organization in a new skill for that individual. They will evaluate the abilities of the individual in this new skill and provide that evaluation to the individual's manager for their annual review.

### Stakes/Guardrails:

1) Over the coming year, each individual will spend a maximum of $250 and 20 hours of work time accomplishing this outcome. The individual's manager must approve additional work time and/or costs.
2) This is an important aspect of maintaining a nonlinear system and should not be sacrificed for deadlines. If adequate time (20 hours over a year) has not been freed up for an individual, that individual's manager is to be held accountable for the failure to achieve this outcome, not the individual.
3) This outcome applies to everyone, even managers and executives, who are encouraged to learn diverse skills from within the organization, preferably from people below their grade level-which is one path, but not the only one, that drives towards Desired Result number 3.
4) As the intention is to create positive interactions, if a negative interaction occurs, stop the interaction. An HR representative should be engaged if any values are compromised or any disrespectful interactions occur. If not that severe, the agents can attempt to resolve the interactions themselves or simply choose a new partner to achieve the desired results.

This depth of outcome documentation provides powerful levels of accountability, flexibility, and creativity due to the addition of the desired results and rules. Rather than simply being forced to accomplish a goal as documented, individuals are invited to create their own ways of achieving the desired results within the structure of the goals and stakes. For example, perhaps a manager who is studying for an MBA works with a C-suite leader to create and present at the company's board of directors meeting. This fulfills both the desired results and stakes but does not meet the metric of presenting with participants providing input to the person's annual review. This manager could justify that the outcome was met, and rightly so. This mechanism of setting outcomes encourages and enables creativity, participation, and ownership in the workforce. In addition, it forms the foundation for the Level II and Level III skills. It may be noted here that the NMS gives a lower priority to suggested SMART goals and a higher priority to desired results and rules as the drivers of work.

Similar to creating any vision or goal statements, the nonlinear manager must meet with all the stakeholders within a given boundary to get the inputs and buy-in on the outcomes for a given team(s). The nonlinear manager must, therefore, also balance all the outcomes to ensure that there are no conflicting outcomes and that all outcomes are achievable by the team members when taken as a whole.

Considering the various example boundaries suggested above, each of which has a range of stakeholders and contributes to creating the outcome documentation. A large part of enabling a healthy NMS is providing the correct outcomes. The nonlinear managers are responsible for this work.

Outcomes are one of the most powerful aspects of the success of the nonlinear manager. The system will self-organize around these outcomes.

Critical rules and flows cover areas of compliance and governance and should be used sparingly for only those aspects of behavior that are absolutely required. Critical rules may include, for example, the handling of private customer information. This is not an area of suggestion; it is a compliance issue that all agents must abide by.

An example of a critical would be how money is handled at the organization. This may include budgets for spending but also rules for payments and taxes. These are areas that need to clearly identify how much adaptation agents are allowed to introduce and where precisely the line is that they cannot change.

Self-organization is a critical aspect of the NMS. Managers need to excel at reining in or relaxing the rules around self-organization based on individuals as well as teams' current trajectory toward outcomes. The NMS provides specific guidelines on what, when, and how changes to the system can and should be made, including how to involve a broad range of stakeholders in those changes. For example:

If the change will impact other teams, get buy-in first or establish mutual rules (specifications/interfaces) for allowing changes.

If the change impacts the delivery of an outcome, communicate it ahead of time across all impacted systems.

Always measure the impact and self-correct quickly.

The Plan, Anticipate, and Execute layer is where the elements and interconnections get combined to accomplish the goals of planning, anticipating the future, and executing outcomes.

Elements may be termed as the “nouns” of the system, the things seen and used. As such, elements are usually the easiest parts of a system to identify. Elements consist of People, Processes, and Tools & Artifacts. All elements are subordinate to the outcomes; that is, elements can be used, altered, added to, or removed as necessary to achieve specific outcomes.

The element “people” includes not just the individuals but also their roles and responsibilities, staffing levels, onboarding, job training, compensation, etc.

The element Processes includes any existing processes (QA, road mapping, gate reviews, market research, Jobs-to-be-Done, etc.) These processes may themselves be linear, which is okay so long as they are flexible enough to change when needed to serve the outcomes.

The element Tools & Artifacts includes anything the People use in service of their work towards outcomes. This can include software, physical devices, financial reports, documents, templates, roadmaps, etc. These are subordinate to the outcomes and need to flex, be added to, replaced, or removed to serve the outcomes.

Systems are living, dynamic things; they are not static. The interconnections are the lifeblood of the system, which keeps the system running.

The easiest interconnections to understand are by looking at the flows of information and work. These interconnections can be synchronous, such as meetings, interviews, gate reviews, parties, and the like. They can be asynchronous, such as email, chats, social media, or document reviews. They can be formal, such as regularly scheduled Agile ceremonies, or informal such as chatting in a break room. Interconnections may include relationships as well, for example, the relationship of an individual with a stakeholder in the system. A big part of the nonlinear manager is to invest and maintain working relationships with other stakeholders. This has several advantages, not the least of which is obtaining information from other parts of the organization and building goodwill with others who can then help when needed.

Interconnections also include decisions. Decisions are inflection points that direct (or redirect) flow in the system. How decisions get made, who makes them, who is affected by them, and how they are communicated are all important considerations in relation to interconnections. A big part of self-organizing in an NMS is deciding how decisions will be made, whose role it is to make decisions, which decisions, and how those decisions are communicated.

Additional critical interconnections are work hand-offs, where responsibility for accomplishing certain work or tasks is handed from one agent to another or from one group to another. For a healthy nonlinear system, these handoffs must be clearly and transparently defined so that accountability for work done (or not done) is maintained. Some examples of this in the Agile Scrum framework include daily standup meetings (an interconnection) and the Definition of Ready and Definition of Done (rules). Each of these provides transparency and regulation of the flow of work.

An important part of the nonlinear manager's role is to manage systems flows to ensure ongoing success. The nonlinear management system provides tools for analyzing its rhythm and flows, as well as securing the correct mindset and actions to maintain or improve system performance by driving the system toward synergy or moving away from system interference.

The NMS, having a nonlinear mindset, is adapted to sense and adjust to the environment based on the kind of inputs that it receives. It interacts with all the stakeholders in the system and based on that, a rhythm of interactions develops, which drives the system forward. It is also self-learning and provides intuitive solutions in a nonlinear manner. Therefore, there are capabilities akin to machine learning and artificial intelligence.

The system experiences different rhythms at different times. There is a rhythm for when everything is working, and everyone is fulfilled and operating at top capacity. There is a rhythm for when a crisis hits and another for when a team is processing difficult learning. A rhythm for when fear is present, such as rumors of layoffs, and a rhythm for when team members leave. Each day, each shift in the environment may produce a new rhythm. The NMS is designed to sense the rhythm and support it, providing life support when needed or letting it work in the way it does if it is running smoothly. The goal is to support a sustainable system, one that can carry on through many changes and disruptions.

In traditional management practices, work rhythms were monitored through temperature charts or Gantt charts, measuring the likelihood of achieving goals on time with the given resources. Your choices for changing rhythm were to speed up the amount of work being done or to add more resources. The only rhythm that mattered was the rate at which work was being done.

In a nonlinear system, the rhythm is about the people and how they interact. There is no specific desired rhythm because, for example, in a crisis, a highly active rhythm may help achieve an outcome, while a noncrisis rhythm may have a more experimental pace. The only unhealthy rhythm is one that cannot be sustained, yet the system is pushing to sustain it. In the same example of a crisis, a traditional manager might look at what can be achieved in a short time and decide that teams should work at that level all the time, thus increasing production. However, the rhythm cannot be sustained forever; people will burn out and leave, and the system will break down.

System flows are a way of analyzing the system by tracing the movement of valuable resources through the system. The most apparent systems flows are the flow of information and the flow of work. System flows provide an easily accessible way of looking at both mindsets and rhythms.

When looking at flows it is important to remember that more of something is not necessarily better—for example, there is such a thing as information overload. The goal of analyzing system flows is to know the optimal level and manipulate the boundaries, outcomes, elements, and interconnections of the system to get to the optimal flow levels.

System flow analysis includes examining inflows and outflows, critical handoffs, content format, optimal levels, and joint work. General flows include the flow of information, work, money, recognition, accountability, diversity, and powerful interconnections. In addition to the above flows, each system may have its own additional flows to monitor, such as safety, customer validation, or quality.

At the React and Respond level are data points that exist in the present moment, that is, usually without context. Dashboards that tell you where something is at this moment, such as total revenue for the quarter, are helpful but, on their own, are fairly ineffective. Trending this data over time, which would be part of Level 3, is more helpful, but leaders and managers are cautioned against putting too much emphasis on a single data point, such as a single customer opinion. Build your muscles beyond reacting quickly and simply let present-moment data lead you to a curiosity as to its deeper meanings.

Spanning all the levels are two NMS management tools—feedback loops and levers.

Feedback loops are information channels that complete a cause-and-effect loop, allowing nonlinear managers to make adjustments in the system. Feedback loops can be passive, such as metrics that are reported to you, or they can be interactive, such as interviewing customers on the effect of the latest release of your product. The NMS, as a whole, thrives on feedback loops, as they are a critical component to alert agents to changes in the system or environment and ultimately allow the system to quickly and efficiently adapt based on the feedback.

Feedback loops ensure that the system improves with every iteration and that any deviation away from outcomes is corrected quickly (including lazy workers, which is why such people do not last long in nonlinear systems).

Leaders and managers should implement feedback loops at all levels of their business system to monitor and fine-tune their system frequently.

System levers are tools managers use to make large changes through small efforts. As systems are in a constant state of change and evolution, managers need levers to help those systems evolve. The NMS begins with the levers listed by Donella Meadows in “Leverage Points, Places to Intervene in a System” (Meadows, 1999) and reinterprets them with the aim of keeping a nonlinear business management system healthy and moving towards the outcomes regardless of what changes show up.

When using levers, keep a close eye on the outcomes. Levers are a great way to introduce innovation; however, one must stay focused on outcomes and be prepared for people to encounter resistance to changing the status quo, sacred cows, and other unwritten expectations of the system.

Levers include anything with numbers, the size and flexibility of buffers in the system, system strains, timing and strength of feedback loops, utilizing crowd wisdom/herd mentality, accountability, rules, self-organization, and building and transcending the system mindset.

Evaluate all leverage points for the best one to make the change with.

The NMS is a dynamic system, always in motion and constantly adapting to new information and innovation. The role of the NMS is to know and respect all the parts of the system and know what to change and when, and then measure the effect of that change in order to achieve specified outcomes. Whether performed manually or through computer-implemented components of these elements together, the NMS will aid organizations in achieving outcomes faster and with more innovation.

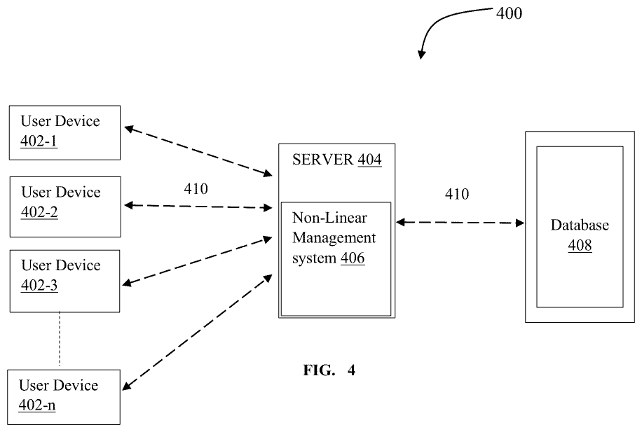

FIG. 4 illustrates a computer-implemented Nonlinear Management System network configuration or architecture. The network architecture 400 implements the NMS 406 in an organization's framework. The architecture 400 includes a plurality of users 402-1, 402-2, 402-3 . . . 402-n (or 402, when referred to collectively) connected to a server 404 implementing therein the system 406 over a network 410. Server 404 is shown to be in communication with database 408, which may store information pertaining to the various organizational fundamentals that need to be taken into consideration to present a nonlinear model or representation of the system fundamentals, flows, and rhythms as discussed above. The network facilitates user/system interactions with one another over a network (such as LAN, WAN, and the like) to facilitate the functionality described herein. In various embodiments, the network may include transmitters and receivers (not illustrated), cellular telecommunication network equipment and interfaces, and/or other computer network equipment and interfaces to send and receive data as described herein. The system may receive inputs from the users, for example, a manager, via a user device 402 to manage a particular outcome within a given boundary and using elements and interconnections within the organization. System 406 takes up the data received as input and analyzes it in a nonlinear manner to identify potential changes to the organizational framework for a given goal and provides a visual representation of the framework in a layered form comprising the primary layer, the intermediate layer, and the expert layer. System 406 may also optimize the framework by implementing at least one potential change as proposed NMS and continuously monitoring and adjusting the framework to maintain organizational efficiency and effectiveness.

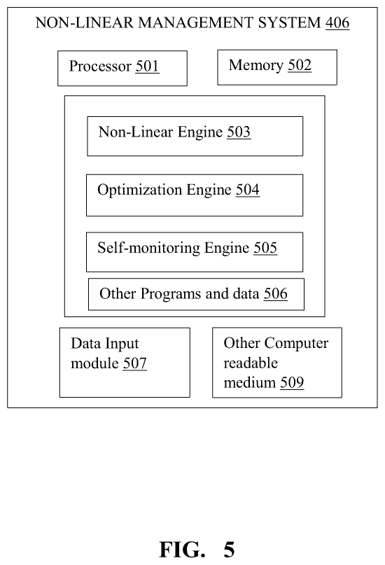

FIG. 5 illustrates a computer-implemented system 406 for managing the framework of the organization. System 406 comprises a processor 501 configured to execute a set of program instructions, which may include AI, stored in memory 502, which provides a user with a visual representation of the framework via a display unit (not shown). Further, the visual representation is configured to display the set of fundamentals in a layered structure with the application of a nonlinear mindset at a level suitable for the understanding of the user. The nonlinear management system comprises a nonlinear engine 503, an optimization engine 504, a self-monitoring engine 505, other programs and data 506, a data input module 507 and database 508.

The nonlinear engine 503 is configured to manage the various input data and parameters as received by the NMS 406, via data input module 507, based on a set of predefined rules, as may be stored in database 408. The optimization engine 504 is configured for optimizing the framework by implementing at least one potential change as proposed by the system. The self-monitoring engine 505 is configured to monitor and adjust the framework continuously to maintain organizational efficiency and effectiveness. The input data may include at least one of a boundary and an outcome.

In some embodiments, one or more special-purpose computing systems may be used to implement the functionality described herein. Accordingly, various embodiments described herein may be implemented in software, hardware, firmware, or in some combination thereof.

Memory 502 may include one or more various types of non-volatile and/or volatile storage technologies. Examples of memory may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 502 may be utilized to store information, including computer-readable instructions that are utilized by the CPU to perform actions, including those of embodiments described herein. Further, memory 502 may have been stored thereon in the control module, not shown in FIG. 5. The control module(s) may be configured to implement and/or perform some or all of the functions of the systems, components, and modules described herein for system 406 to manage the framework of the organization. The memory may also store other programs and data, which may include rules, programs, or models to perform the functionality described herein, user interfaces, operating systems, other nonlinear management functions, etc.

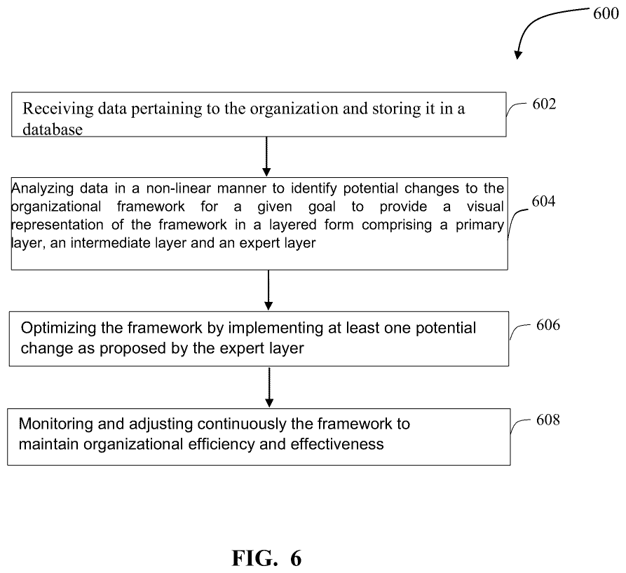

FIG. 6 discloses method 600 for managing the framework of an organization with a nonlinear mindset.

Step 601 is an analysis step that allows for a deep understanding of the existing organization prior to the implementation of the NMS. Many of the components of the existing system will be altered, removed, or replaced once the NMS is implemented, but an understanding of the initial state is critical to begin with.

Step 602 establishes and clarifies all the boundaries and outcomes for the new NMS.

Step 603 establishes and clarifies all the elements and interconnections that are necessary, or believed to be necessary, to achieve the outcomes established in step 602.

Step 604 maps the system flows and values believed to be in existence at the start of the NMS implementation.

Step 605 is usually triggered by a feedback loop providing insight that innovation is available to achieve the outcomes in a better way or that there is a change that is taking the system off the path to achieving the outcomes. These opportunities/needs can be dealt with through the tools specified in the expert layer in order to set the system back to a path of achieving the outcomes, even if that path is radically different from the last path they were on.

When first setting up the system, it is recommended to follow steps 601-604 sequentially. Once data has been acquired, all steps are ongoing simultaneously or in any order deemed necessary by the manager, team, or recommended by the system in order to achieve the specified outcomes.

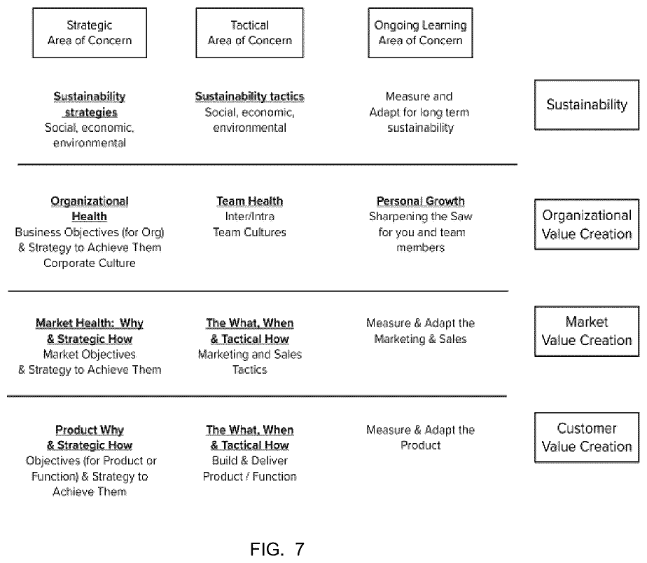

FIG. 7 represents the major areas of concern for which nonlinear managers need to create and manage boundaries and outcomes. Nonlinear managers need to create and manage boundaries and outcomes in three major areas: strategic, tactical, and learning and adaptation.

Nonlinear managers need to establish boundaries by defining the organization's strategic direction, long-term goals, and objectives.

Nonlinear managers need to create boundaries at the tactical level, which involves translating strategic objectives into actionable plans and initiatives.

Nonlinear managers must create boundaries for continuous learning and adaptation within the organization. They need to foster a culture of learning, encourage experimentation, and provide opportunities for knowledge sharing and skill development. By setting these boundaries, nonlinear managers create an environment that promotes innovation and agility. They must also manage outcomes by evaluating the effectiveness of learning initiatives, tracking the application of new knowledge and skills, and adjusting approaches based on feedback and changing circumstances.

These three areas-strategic, tactical, and learning and adaptation-are interconnected and crucial for nonlinear managers to navigate complexity and drive organizational success. By effectively creating and managing boundaries and outcomes in these areas, nonlinear managers can promote alignment, agility, and continuous improvement within their teams and organizations.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

What is claimed is:

1. A human- and/or computer-implemented system for managing a framework of an organization in a nonlinear manner, the framework having a set of fundamentals and interconnections within the organization, the system comprising a user device, a server, and a processor configured to execute a set of program instructions which provides a user with a visual representation of the framework via a display unit of the user device, wherein the visual representation comprises:
a transformation layer for managing the nonlinear mental model including mindset, coping with unpredictable changes, enacted values, and aspects of culture;
a goals and controls layer comprising various parameters, including boundaries, outcomes, critical compliance rules and flows, and the degree of support for agent self-organization;
a plan, anticipate, and execute layer configured to manage the people, processes, tools, artifacts, interconnections, and system rhythms from a nonlinear mindset to ensure ongoing success, including tracing the flows of valuable resources;
a layer upon which to assess the response/reactions to present moment information,
wherein the layers are arranged in an ascending manner starting from the transformation layer to the respond/react layer;
a data input module for receiving an input defining at least one of the boundaries and an outcome; and
a database for fetching the various attributes stored in input information by the user and pre-defined parameters governing fundamentals essential to the organization.

2. The system, as claimed in claim 1, wherein the elements include people, processes, and tools, wherein the people elements include specific individuals responsible for performing work in the system.

3. The system as claimed in claim 1, wherein the processes elements include formal processes, meetings, schedules, and documentation, and the tools elements include computers, software, hardware, manufacturing tools, and office tools.

4. The system as claimed in claim 1, wherein the rules elements include decision-making, budget limits, quality standards, or target release dates.

5. A framework for managing a team or organization in a nonlinear manner, the framework having a set of fundamentals and interconnections within the organization, the method comprising a set of program instructions executed by a user device, a server, and a processor configured to provide a user with a visual representation of the framework via a display unit of the user device, wherein the visual representation comprises:
receiving, via a data input module, data pertaining to the organization and storing said data in a database;
analyzing, via machine learning, nonlinear data in a nonlinear manner to identify potential changes to the organizational framework;
optimizing the framework by implementing the identified changes, wherein optimization of the framework comprises:
managing, via a transformation layer for managing the nonlinear mental model including mindset, coping with unpredictable changes, enacted values, and aspects of culture;
managing via a goals and controls layer comprising various parameters, including boundaries, outcomes, critical compliance rules and flows, and the degree of support for agent self-organization;
managing via a plan, anticipate, and execute layer configured to manage the people, processes, tools, artifacts, interconnections, and system rhythms from a nonlinear mindset to ensure ongoing success, including tracing the flows of valuable resources;
managing via a layer upon which to assess the response/reactions to present moment information,
wherein the layers are arranged in an ascending manner starting from the transformation layer to the respond/react layer;
providing a user interface to access and input data into the system; and
monitoring and adjusting continuously the framework to maintain organizational efficiency and effectiveness.
